(19) United States
(12) Patent Application Publication
(10) Pub. No.: US 2003/0016266 A1
(43) Pub. Date: Jan. 23, 2003

(54) Linear position encoding system

(76) Inventor: Johannes Wilhelmus Maria Urselmann, Mierlo (NL)

Correspondence Address: BIRCH STEWART KOLASCH & BIRCH, PO BOX 747, FALLS CHURCH, VA, 22040-0747, US

(21) Appl. No.: 10/198,107

(22) Filed: Jul. 19, 2002

(30) Foreign Application Priority Data
Jul. 20, 2001 (EP) 01202776.9

(51) Int. Cl. B41J 23/00

(52) U.S. Cl. 347/37

(57) ABSTRACT

A linear position encoding system for a moving a carriage carrying at least two active elements that are spaced apart in the direction (X) of movement of the carriage, comprising a codestrip extending along the path of movement of the carriage and having a plurality of position marks detectable by a sensor mounted on the carriage, wherein the codestrip has the same thermal expansion coefficient as the carriage.

### BACKGROUND OF THE INVENTION

The present invention relates to a linear position encoding system for a moving carriage carrying at least two active elements that are spaced apart in the direction of movement of the carriage. The invention includes a codestrip extending along the path of movement of the carriage and having a plurality of position marks detectable by a sensor mounted on the carriage.

The present invention is applicable, in particular, to printers, plotters or scanners, wherein the carriage carries, as active elements, printing elements, pens and photoelectric sensing elements, respectively.

An example of an encoding system of this type is disclosed in EP-A-0 807 528, which relates to an ink jet printer. The carriage is movable in a main scanning direction relative to a platen on which a recording sheet, e.g., paper, is fed in a subscanning direction orthogonal to the main scanning direction. The printing elements carried on the carriage are formed by nozzles from which ink droplets are expelled onto the recording sheet under the control of a printer control system. The nozzles are arranged in rows extending in parallel with the subscanning direction, so that, during each scan pass of the carriage, a number of lines corresponding to the number of nozzles in a row can be printed. The encoding system is used for determining the timings at which the individual nozzles are to be fired in accordance with the image information to be printed. The position marks on the codestrip may be formed by dark bars on a light background or vice versa, that are arranged in a very fine regular pattern and may be detected by an optical sensor mounted on the carriage. As an alternative, in case of a transmission-type codestrip, the position marks may be formed by transparent slits in an opaque substrate.

The accuracy of position detection achieved with the encoding system is subject to errors which may result, among others, from thermal expansion of the codestrip. In the known system, such errors are compensated for by providing two sensors that are mounted on the carriage with a well-defined spacing in the main scanning direction. On the basis of the known distance between the two sensors, the position signals provided by the encoding system can be calibrated electronically. It is a prerequisite however, that the distance between the two sensors is known exactly and is, itself, not subject to any substantial thermal expansion effects.

In case of an ink jet color printer, the printhead on the carriage comprises a plurality of parallel rows of nozzles, e.g. one for each of the four basic colors cyan, magenta, yellow and black. These rows are spaced apart in the main scanning direction, and the offset between the rows has to be compensated for by appropriately controlling the firing timings of the nozzles on the basis of the position information provided by the encoding system. Composite colors are printed by combining dots of ink in the various basic colors. Then, the hue of a printed pixel, e.g. a green pixel obtained by combining dots in cyan and yellow, will depend on the amount of overlap between the dots in the basic colors. In order to obtain a high quality printed image, it is therefore important that the dots printed with different nozzle rows can be registered with high accuracy. However, thermal expansion or shrinkage of the carriage may lead to changes in the offsets between the different rows of nozzles, which limits the registration accuracy.

Since the hue of a color pixel depends not only on the amount of overlap between the dots but also on the sequence in which the dots are printed, it has been proposed to use a printhead in which two nozzle rows are provided for each color and the rows dedicated to the various colors are arranged mirror-symmetrically, so that the sequence in which the color dots are printed may be same in the forward stroke and the return stroke of the carriage. Then, however, the length of the carriage in the main scanning direction must be increased further, and the printer will be even more sensitive to thermal expansion of the carriage.

The problem caused by thermal expansion or shrinkage of the carriage is not only encountered in ink jet printers but, more generally, in any kind of printer in which printing elements are spaced apart in the main scanning direction and it is nevertheless necessary to register the sub-images printed with the different printing elements. A similar problem occurs in plotters, for example when a line that has been drawn with a first pen shall be continued smoothly with the use of another pen. In a scanner, the active elements may be optical sensors that are sensitive to different wavelengths of light. Here, in order to correctly determine the color of a scanned pixel, it is also important that the offset between the two sensors is compensated for correctly by controlling the sample timings.

In order to obviate the problem caused by thermal expansion of the carriage it is of course possible to use a carriage made of a material that has a thermal expansion coefficient close to zero. This, however, leads to increased costs for the carriage.

Another approach is to provide a sensor for detecting the temperature of the carriage and to compensate electronically for the effect of thermal expansion. However, this also adds to the complexity and costs of the hardware and requires additional capacity for electronic data processing.

### SUMMARY OF THE INVENTION

It is an object of the present invention to provide a simple and inexpensive linear position encoding system which is tolerant to thermal expansion or shrinkage of the carriage and does not require a measurement of the temperature of the carriage.

According to the present invention, this object is achieved by a system wherein the codestrip has the same thermal expansion coefficient as the carriage.

Since the codestrip is arranged in close proximity to the carriage and, hence, is subject to the same environmental temperature as the carriage, the effect of thermal expansion or shrinkage of the carriage is automatically canceled by a corresponding thermal expansion or shrinkage of the codestrip. Thus, once the timing control for the active elements has been adjusted so that the offsets between the different active elements are compensated for, this compensation will be maintained regardless of any temperature changes.

It is accordingly a remarkable advantage of the present invention that an inexpensive material with a non-zero thermal expansion coefficient can be used not only for the carriage but also for the codestrip. Of course, the codestrip must be mounted in such a manner that it is free to expand and shrink under temperature changes. This, however, is required for a high quality codestrip, anyway, in order to prevent the codestrip from bulging or becoming distorted in the case of differential thermal expansion of the codestrip and the machine frame. Mounting structures allowing such a free thermal expansion or contraction of the codestrip are well known in the art. For example, the codestrip may be fixed at one end and slidably supported at the other end, or it may be fixed in the center and slidably supported at both ends.

Since the codestrip should provide a high spatial resolution and, accordingly, must have a pattern of very fine position marks arranged with a very small pitch, the substrate on or in which the position marks are formed must fulfill specific requirements in order for the sensor to produce a well-defined detection signal. In a preferred embodiment, the position marks are formed in a resinous substrate such as a polyester that is fixedly attached (e.g. by gluing or coating) to a carrier strip whose rigidity and tensile strength is significantly larger than that of the substrate. The thermal expansion coefficient will be determined alone by the material of the carrier strip and will not be substantially influenced by the material of the substrate. For example, the carriage and the carrier strip may be made of the same metal material, e.g. stainless steel or aluminum, and the substrate for the position marks may be formed by a polyester film on the carrier strip. In order to provide a transmission type codestrip, the part of the polyester film carrying the position marks may project beyond the edge of the carrier strip.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic, perspective view of an ink jet printhead carriage traveling along the platen of a printer, together with a position encoding system according to the present invention;

FIG. 2 is a front view of the printhead;

FIG. 3 is a diagram illustrating the effect of thermal shrinkage of the carriage;

FIG. 4 is a diagram similar to FIG. 3 illustrating a register error between dots printed with different nozzles of the printhead; and

FIG. 5 is a diagram illustrating how to compensate for the registration error in accordance with the present invention.

### DETAILED DESCRIPTION OF THE INVENTION

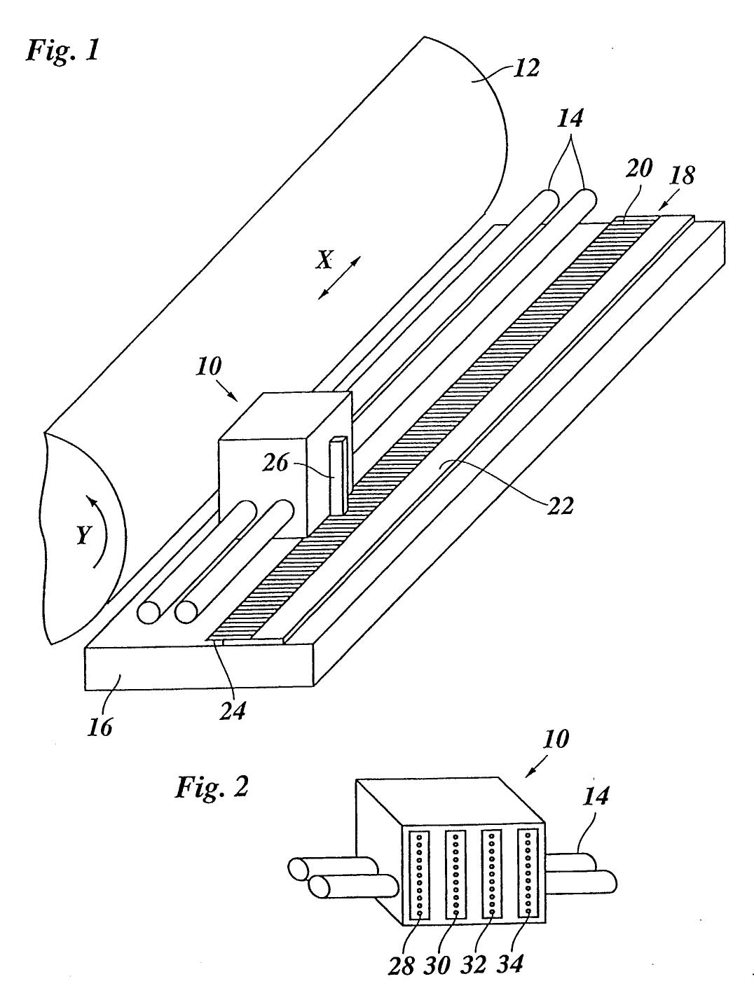

In FIG. 1, a carriage 10 carrying an ink jet printhead is moved back and forth in a main scanning direction X along a platen 12 on which a printing medium is transported in a subscanning direction Y normal to the main scanning direction. The carriage 10 is guided on guide rails 14 which are mounted in a fixed position in relation to the platen 12 and a frame body 16. A codestrip 18 having a plurality of position marks or slits 20 is fixed to the frame body 16 and extends along the guide rails 14. The codestrip 18 comprises a carrier strip 22 made of the same material as the carriage 10, e.g. stainless steel, and a substrate of polyester film 24 in which the slits 20 are formed and which is firmly attached to one surface of the carrier strip 22 so as to project beyond one edge of the carrier strip.

An optical sensor 26 is fixedly mounted on the carriage 10 with its sensitive portion facing the projecting part of the polyester film 24. Thus, when the carriage 10 moves in the main scanning direction X, the slits 20 can be detected with the sensor 26, and the sensor delivers a pulse train corresponding to the sequence of slits. By counting these pulses, an electronic control circuit (not shown) of the printer can determine the position of the carriage 10 in X-direction with high accuracy. The positional accuracy depends on the pitch with which the slits 20 are arranged on the codestrip 18, but may be improved by interpolation techniques on the basis of the known velocity of the carriage 10.

As is shown in FIG. 2, the printhead carriage 10 comprises four rows of ink jet nozzles 28, 30, 32 and 34 for the four basic colors cyan, magenta, yellow and black. The rows extend in the subscanning direction and are spaced apart from each other in the main scanning direction.

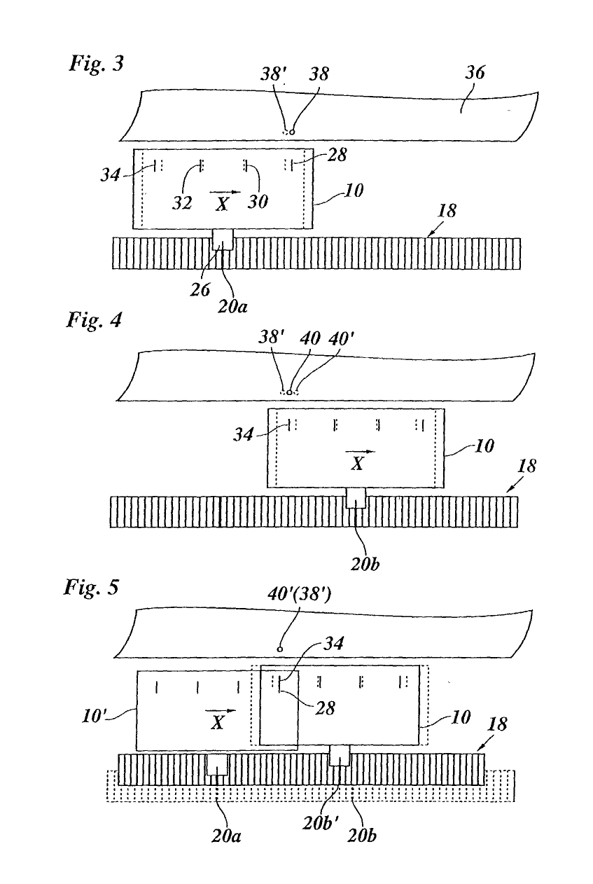

FIG. 3 diagrammatically shows a portion of a recording sheet 36 placed on the platen 12, and a plan view of the carriage 10 and the encoding system formed by the sensor 26 and the codestrip 18. The positions of the nozzles 28-34 and the position of the sensitive part of the sensor 26 are indicated by short vertical lines.

When, in FIG. 3, the carriage 10 or, more exactly, the sensitive part of the sensor 26 has reached the slit 20a, the nozzle 28 is energized to print an ink dot 38 on the recording sheet 36.

When the carriage 10 undergoes thermal contraction, the positions of the nozzles 28-34 slightly shift, as has been shown exaggeratedly in dotted lines in FIG. 3. Then, the ink dot 38 would be printed in the position 38′ which is slightly shifted relative to the intended position. However, since all dots printed with the same nozzle 28 will be shifted in the same way, this does not lead to a distortion of the printed image but only to a minor shift of the image as a whole, which is not perceptible to the human eye.

Thermal expansion or shrinkage of (only) the carriage 10 does however cause a problem when a predetermined positional relationship (register) is to be maintained between ink dots printed with the different nozzles 28, 30, 32 and 34. For simplifying the discussion, it shall now be assumed that the nozzle 34 shall be energized at an appropriate timing so as to print an ink dot right on top of the already printed dot 38. The carriage moves in the direction X to the right in FIGS. 3 and 4. As is shown in FIG. 4, when the carriage 10 is not subject to thermal shrinkage, the nozzle 34 must be energized when the carriage has reached the slit 20b which, in this example, is twenty slits away from the slit 20a. Now, thermal shrinkage has the effect that the nozzle 34 prints the dot actually in the position 40′ which is considerably offset from the position of the dot 38′.

In the discussion of FIGS. 3 and 4 is has been assumed that thermal changes affect only the carriage 10 but not the codestrip 18.

In FIG. 5, the carriage in the condition with thermal shrinkage has been shown in continuous bold lines, whereas the original contour of the carriage has been indicated in dotted lines. Since, according to the present invention, the carrier strip 22 which determines the thermal expansion behavior of the codestrip 18 is made of the same material as the carriage 10 and hence has the same thermal expansion coefficient, the codestrip 18 undergoes the same percentage of thermal shrinkage as the carriage 10. FIG. 5 shows the condition of the codestrip 18 with thermal shrinkage in continuous lines. For comparison, the original state of the codestrip has been shown in dotted lines (with a slight vertical offset). Faint continuous lines indicate the position 10′ of the carriage (with thermal shrinkage) at the time when the nozzle 28 prints the dot 38′ (the position 10′ has also been shown with a slight vertical offset for reasons of clarity).

As shown in FIG. 5, the nozzle 34 prints the dot 40′ when the carriage 10 has traveled twenty slits further to the position 20b′ which is shifted from the original position 20b due to the thermal shrinkage of the codestrip 18. Thus, when the sensor detects the position 20b′, the nozzle 34 coincides with the position of the dot 38′, and the new dot 40′ is again printed right on top of the previous dot. This means that the effect of thermal shrinkage of the printhead 10 is completely compensated for by the thermal shrinkage of the codestrip 18.

Thermal shrinkage or expansion of the codestrip 18 and the carriage 10 will only have the effect that the printed image, as a whole, undergoes a corresponding shrinkage or expansion in width direction, but this minor distortion is not perceptible to the human eye.

In FIG. 5, it has been assumed for simplicity that the codestrip 18 is fixed relative to the frame body in the position of the slit 20a, so that the slit 20a does not move due to thermal expansion or shrinkage. However, any change in the position of the slit 20a would have affected the positions of both dots 38′ and 40′ exactly in the same way, so that the effect of thermal expansion is eliminated regardless of where the codestrip is fixed to the frame body. The reason is that, thanks to the identical thermal expansion coefficient of the carriage 10 and the codestrip 18, the distance between the nozzles 28 and 34 on the carriage is always, for any temperature, identical with the distance between the corresponding slits 20a and 20b on the codestrip.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A linear position encoding system for a moving carriage which carries at least two active elements spaced apart in the direction (X) of movement of the carriage, which comprises:
a codestrip extending along the path of movement of the carriage and having a plurality of position marks, said codestrip having the same thermal expansion coefficient as the carriage, and
a sensor mounted on the carriage for detecting the position marks, wherein the sensor comprises a single sensor for controlling the timing at which said at least two active elements are activated, wherein the time difference between the activation timing of two active elements corresponds to a fixed number of position marks to be detected by the sensor.

2. The system according to claim 1, wherein the codestrip comprises a substrate on which or in which the position marks are formed, said substrate being fixed to the carrier strip which has a higher rigidity than the substrate, so that the thermal expansion behavior of the codestrip is determined by the carrier strip.

3. The system according to claim 2, wherein the carrier strip is made of the same material as the carriage.

4. The system according to claim 2, wherein the substrate is made of a synthetic resin.

5. The system according to claim 3, wherein the substrate is made of a synthetic resin.

6. The system according to claim 2, wherein the substrate is a film which projects beyond on edge of the carrier strip.

7. A printer containing the linear position encoding system of claim 1, wherein the moving printhead carriage contains a plurality of printing elements.

8. The printer according to claim 6, wherein said printing elements are ink jet nozzles.
